(19) United States
(12) Patent Application Publication
(10) Pub. No.: US 2026/0109866 A1
(43) Pub. Date: Apr. 23, 2026

(54) TWO COMPONENT POWDER COATING COMPOSITION WITH SEPARATED CATALYST SYSTEM

(71) Applicant: ALLNEX NETHERLANDS B.V., Bergen Op Zoom (NL)

(72) Inventors: Pengcheng YANG, Arnhem (NL); Richard Hendrikus Gerrit BRINKHUIS, Zwolle (NL)

(73) Assignee: ALLNEX NETHERLANDS B.V., Bergen Op Zoom (NL)

(21) Appl. No.: 19/116,002

(22) PCT Filed: Nov. 6, 2023
(86) PCT No.: PCT/EP2023/080824

§ 371 Date: Mar. 27, 2025

(30) Foreign Application Priority Data
Nov. 7, 2022 (EP) 22205824.0

(51) Int. Cl. C09D 5/03; C09D 7/61; C09D 175/04

(52) U.S. Cl. CPC C09D 5/033; C09D 7/61; C09D 175/04

(57) ABSTRACT

The invention is related to a two component powder coating composition AB comprising paint component A and paint component B, wherein the powder coating composition AB comprises a crosslinkable composition, formed by a crosslinkable donor component (i) and a crosslinkable acceptor component (ii) that are crosslinkable by a Real Michael Addition (RMA) reaction, a catalyst system comprising a catalyst precursor (P) and a catalyst activator (C), which are separated so that paint component A comprises the catalyst precursor (P); and paint component B comprises the catalyst activator (C); optionally a non-RMA reactive component (iii) different from the donor component (i), the acceptor component (ii), the catalyst precursor (P) and the catalyst activator (C), which is not a pigment or a filler; wherein the coating composition AB comprises a crystalline component CC, that is present in an amount from 1 to 50 wt %, in view of the total weight of the catalyst system, the crosslinkable composition and if present the non-RMA reactive component (iii); whereby at least part of the donor component (i) and/or acceptor component (ii) and/or the non-RMA reactive component (iii) is the crystalline component CC; and wherein both paint components A and B comprise the donor component (i) and the acceptor component (ii).

### FIELD OF THE INVENTION

Current invention relates to a two component powder coating composition AB comprising a crosslinkable composition that is crosslinkable via Real Michael Addition (RMA) and a separated catalyst system comprising a precursor P and an activator C; a method for preparing the two component powder coating composition, a process for coating articles using said powder coating composition, and the coated articles.

### DESCRIPTION OF THE RELATED ART

Powder coatings are dry, finely divided, free flowing, solid materials at room temperature and have gained popularity in recent years over liquid coatings. Powder coatings are generally cured at elevated temperatures between 120° C. and 200° C., more typically between 140° C. and 180° C. High temperatures are required to provide for sufficient flow of the binder to allow film formation and achieve good coating surface appearance, but also for achieving high reactivity for a crosslinking reaction. At low curing temperatures, one may face reaction kinetics that will not allow short cure times when demanding full mechanical and resistance property development; on the other hand, for systems where a high reactivity of the components may be created, the coatings likely have a poor appearance due to the relatively high viscosity of such systems at such lower temperatures, rapidly increasing further as the cure reaction proceeds: the time-integrated fluidity of such systems is too low to achieve sufficient leveling (see e.g. Progress in Organic Coatings, 72 page 26-33 (2011)).

Patent application WO 2019/145472 describes a powder coating composition that provides a glossy coating on substrates that are heat-sensitive substrates such as medium density fibre-board (MDF), wood, plastics and certain metal alloys and is able to cure at low temperature. This coating composition is curable via RMA using a catalyst system consisting of a catalyst precursor and a catalyst activator.

Patent applications CN112457751 and CN112457752 describe a low temperature RMA curable composition comprising donor, acceptor and (semi)crystalline components, whereby the RMA catalyst activator is added as a separate compound to a paint component comprising the RMA donor, RMA acceptor and RMA catalyst precursor results in a powder coating whereby the gloss value is not very low.

Many powder coating compositions provide coatings having a high gloss after curing. There is an increasing demand for powdered paints and resins which provides coating having a good quality and showing a reduced gloss. Furthermore, it is an advantage if such type of coatings can be applied on heat sensitive substrates such as medium density fibre-board (MDF), wood, plastics and certain metal alloys.

Therefore there is a need for a powder coating composition having good properties, that can cure at low temperatures that provides a very low gloss, dead matt coating and ensures a long shelf life upon storage, while maintaining good mechanical and chemical resistance, adhesion and flow upon cure, can react fast, while the coating has a smooth finish

### BRIEF SUMMARY OF THE INVENTION

Present invention addresses one or more of the above problems by providing a two component powder coating composition AB as described in claim 1.

Accordingly a first aspect of the invention is related to a two component powder coating composition AB comprising paint component A and paint component B, wherein the powder coating composition AB comprises
a crosslinkable composition, formed by a crosslinkable donor component (i) and a crosslinkable acceptor component (ii) that are crosslinkable by a Real Michael Addition (RMA) reaction, wherein
   the donor component (i) has at least 2 acidic C—H donor groups in activated methylene or methine, and
   the acceptor component (ii) has at least 2 activated unsaturated acceptor groups C═C, which react with donor component (i) by Real Michael Addition (RMA) reaction via a catalyst system,
the catalyst system comprising a catalyst precursor (P) and a catalyst activator (C), which are separated so that
   paint component A comprises the catalyst precursor (P);
   paint component B comprises the catalyst activator (C);
   wherein the catalyst precursor (P) is a weak base with a pKa of its protonated form of more than 2 units lower than that of the activated C—H groups in donor component (i); and the catalyst activator (C) can react with P at curing temperature Tur, producing a strong base (CP);
optionally a non-RMA reactive component (iii) different from the donor component (i), the acceptor component (ii), the catalyst precursor (P) and the catalyst activator (C);
wherein the coating composition AB comprises a crystalline component CC that is present in an amount from 1 to 50 wt %, preferably 2 to 40 wt % and more preferably from 4 to 30 wt % in view of the total weight of the catalyst system, the crosslinkable composition and if present the non-RMA reactive component (iii);
wherein at least part of the donor component (i) and/or acceptor component (ii) and/or the non-RMA reactive component (iii) is the crystalline component CC, and
wherein both paint components A and B comprise the donor component (i) and the acceptor component (ii).

In a second aspect, the invention is related to a method for powder-coating a substrate comprising
a. applying a layer comprising the two component powder coating composition AB to a substrate surface wherein the substrate preferably is a temperature sensitive substrate, preferably MDF, wood, plastic, composite or temperature sensitive metal substrates like alloys and
b. heating to a curing temperature Tcur between 75 and 150° C., preferably between 9° and 140° C., more preferably between 10° and 130° C.
c. curing at Tcur for a curing time preferably less than 40 more preferably in less than 30, 20 or even less than 10 minutes.

In a third aspect, the invention is related to articles coated with the two component powder coating composition AB, wherein the articles preferably have a temperature sensitive substrate preferably selected from the group of MDF, wood, plastic or metal alloys and wherein the gloss level is less than 20 gloss units (GU) at 60° angle.

### DETAILED DESCRIPTION OF THE INVENTION

The inventors surprisingly found that the two component powder coating composition AB according to the invention, whereby the catalyst system is separated over paint components A and B, (also called macrophysically separated), and comprises a crystalline component CC present in an amount of from 1-50 wt %, provides a coating composition that can be cured at low temperature with high curing speed, that has a long shelf life and provides a coating with a dead matt appearance, which has a smooth finish and an enhanced curing time.

According to the invention, the term “separated” or “macrophysically separated” means that the reactable components catalyst precursor (P) and the catalyst activator (C) are essentially inaccessible for chemical reaction in the two component powder coating composition below the curing temperature. This is because not all the reactable components of the powder coating composition are melt-mixed (also called extruded) together. In current invention the catalyst system is macrophysically separated.

The inventors found that when the components (P) and (C) are macrophysically separated, and the powder coating composition AB further comprises a crystalline component (CC) then it is possible to provide after curing a coating with a good quality and having a dead matt appearance; i.e. having a gloss level that is less than 20 GU at 60° angle.

Furthermore, since the components (P) and (C) are macrophysically separated, a longer shelf life is obtained.

Furthermore the powder coating composition AB is also suitable for powder coatings that can be cured at low temperatures with a relatively high curing speed, acceptable short curing times and achieve good crosslinking with good coating appearance.

The powder coating composition AB according to the invention can be cured at curing temperature Tcur chosen between 75 and 200° C., preferably between 8° and 180° C. and more preferably between 100 and 160, 150, 140, 130 or even 120° C. and preferably also uses infrared heating. Preferably the melt viscosity at the curing temperature is less than 60 Pas, more preferably less than 40, 30, 20, 10 or even 5 Pas. The melt viscosity can e.g. be measured with a Brookfield CAP 2000 cone-and-plate rheometer according to ASTM D4287, using spindle #5 and is to be measured at the very onset of the reaction or on the powder coating composition AB without catalyst activity.

The low curing temperatures make it possible to use the powder coating composition AB for powder coating temperature sensitive substrates, preferably MDF, wood, plastic, composites or temperature sensitive metal substrates like alloys. The invention therefore also relates in particular to such articles coated with a powder coating composition AB according to the invention. It was found that good coating properties could be obtained with good crosslinking density XLD and resulting good coating properties.

In the context of the present invention the term “crystalline component” is a compound that has a melting temperature Tm above which the compound is liquid. “Crystalline component” also encompasses semi crystalline components.

In the context of the present invention, the “melting temperature” of the (semi)crystalline component is the temperature at which the compound is completely melted. The melting temperature reported herein are determined from Differential Scanning calorimetry (DSC) using a heating rate of 10° C./min.

### BRIEF DESCRIPTION OF THE FIGURES

Aspects of the invention will now be described in more detail. Reference is thereby made to the appended FIGURE.

FIG. 1 describes the isothermal DSC analysis for powder coating composition PW2 and powder coating composition PW4 cured at 120° C.

### DESCRIPTION OF EMBODIMENTS

The two component powder coating composition AB

The two component powder coating composition AB comprises paint component A and paint component B, whereby paint component A comprises the catalyst precursor (P) and paint component B comprises the catalyst activator (C) so that the catalyst precursor (P) and catalyst activator (C) are macrophysically separated.

Paint components A and B further comprise the donor component (i) and the acceptor component (ii). Paint components A and/or B further comprise the crystalline component CC. In a preferred embodiment both paint components A and B comprise the crystalline component CC.

The catalyst system preferably further comprises the retarder (T). The retarder can be present in paint component A and/or B. The retarder (T) is preferably at least present in paint component B.

In a preferred embodiment, the paint components A and B have a Tg higher than 35° C., preferably higher than 40° C. and preferably lower than 60° C., more preferably lower than 55° C., wherein Tg is the midpoint value determined by Differential Scanning calorimetry (DSC) at a heating rate of 10° C./min.

In another embodiment the two component powder coating composition AB is prepared by
melt-mixing components (i) and/or (ii) of the crosslinkable system with the catalyst precursor (P) and optionally the retarder T to obtain component A extrudate;
melt-mixing components (i) and/or (ii) of the crosslinkable system with the catalyst activator (C) and optionally the retarder T to obtain component B extrudate;
solidifying and granulating the component A extrudate and component B extrudate to obtain paint component A and paint component B;
dry blending the paint component A and paint component B to obtain the two component powder coating composition AB.

According to this invention, for the melt-mixing (also called extrusion) standard processes can be used which are typically used for making powder resins. Thereby it is typical that after the extrudate is formed in an extruder, well known by a person skilled in the art, the extrudate is immediately solidified by force-spreading the extrudate onto a cooling band. The solidified extrudate can take the form of a solidified sheet as it travels along the cooling band. At the end of the band, the sheet is then granulated and thus broken up into small pieces (flakes), preferably via a peg breaker. At this point, there is no significant shape control applied to the granules. The granulate can then optionally be transferred to a classifying microniser, where it is further milled and classified. The paint components A and B are then blended to form the two component powder coating composition AB. The solidified flakes deriving from component A extrudate and component B extrudate are eventually micronized, together as a blend. Since the catalyst precursor P and the catalyst activator C are not extruded together they are macrophysically separated in the two component powder coating composition AB.

In a preferred embodiment, the weight ratio of paint components A and B is between 0.1 and 10, preferably 0.2 and 5, more preferably between 0.33 and 3, even more preferable between 0.5 and 2, most preferably between 0.75 and 1.33.

### Crystalline Component CC

The two component powder coating composition AB according to the invention comprises a crystalline component CC that is present in an amount from 1 to 50 wt %, preferably 2 to 40 wt % and more preferably from 4 to 30 wt % in view of the total weight of the catalyst system, the crosslinkable composition and if present the non-RMA reactive component (iii). At least part of the donor component (i), and/or acceptor component (ii) and/or the non-RMA reactive component (iii) is the crystalline component CC. Most preferably, the crystalline component is a donor component (i) or an acceptor component (ii). Accordingly, the crystalline component CC according to this invention is not a component that forms part of the catalyst system and is thus not a catalyst precursor (P), catalyst activator (C) or catalyst retarder (T).

The crystalline component CC is also not a filler material or a pigment material.

It is surprisingly found that the presence of a crystalline component CC in a two component powder coating composition that is RMA crosslinkable, and whereby the catalyst system is separated, provides a powder coating that has a dead matt and smooth appearance.

In one highly preferred embodiment, the two component powder coating composition AB is characterized by a maximum plasticization effect due to melting of the crystalline component CC, calculated as Tgₛₜₒᵣₑ-Tg_{flow}, of 2 to 50° C., preferably 3 to 40° C., more preferably 4 to 30° C., wherein Tgₛₜₒᵣₑ and Tg_{flow} are calculated as

$$\frac{{\sum }_{i = 1}^{n} {W}_{i}}{{Tg}_{store}} = {\sum }_{i = 1}^{n} \frac{{W}_{i}}{{Tg}_{i}} \qquad \frac{{\sum }_{j = 1}^{n} {W}_{j}}{{Tg}_{flow}} = {\sum }_{j = 1}^{m} \frac{{W}_{j}}{{Tg}_{j}}$$

wherein in the formula
   i represents each individual component of the catalyst system, the crosslinkable composition and if present the non-RMA reactive component (iii) not including the crystalline components CC;
   j represents each individual component of the catalyst system, the crosslinkable composition and if present the non-RMA reactive component (iii) including the crystalline component CC;
   Tgi and Tgj represent the glass transition temperature Tg, in Kelvin, as the midpoint value determined by Differential Scanning calorimetry (DSC) at a cooling rate of 10° C./min, of the individual components of the catalyst system, the crosslinkable composition and if present the non-RMA reactive component (iii);
   wi or wj is the weight fraction w of the individual component in view of the total weight of the catalyst system, the crosslinkable composition and if present the non-RMA reactive component (iii).

Tgₛₜₒᵣₑ represents the glass transition temperature of the two component powder coating composition AB at storage temperature wherein CC is in the crystalline state, and which is well below the curing temperature. Only the Tg of each of the amorphous compounds are taken into account for calculation the Tgₛₜₒᵣₑ.

The Tg_{flow} represents the glass transition temperature of the two component powder coating composition AB under conditions that the crystalline components are melted. When the composition is melted the crystalline component CC has a plasticizing effect on the Tg. The crystalline component has a Tg that is much lower than the melting temperature Tm and Tg may be below 50° C., below 40, below 20 or even below 0° C.

According to this invention with maximum plasticization effect is meant the theoretically calculated plasticization effect. Typically, in practice the plasticization effect will be lower than what is calculated and therefore the theoretical effect is referred to as that maximum plasticization effect.

The difference between Tgₛₜₒᵣₑ and Tg_{flow} represents the maximum plasticization effect due to melting of the crystalline component CC, whereby this plasticization reduces the melt viscosity and increases the diffusion coefficients.

According to this invention the range of the maximum plasticization effect is between 2 and 50° C. Below that range, the plasticization may not be sufficient to effectively increase the diffusion coefficients, while above that range, the coating may be too soft after curing and may have lower mechanical or resistance properties. A person skilled in the art will be able to find the amount of crystalline component needed to create the plasticization effect in this window, using the Fox-Flory equation. A lower amount of a crystalline component having lower Tg is needed for the same impact, than of a component with higher Tg.

In one embodiment, the crystalline component CC can have groups that are crosslinkable via RMA and may have at least 2 acidic C—H donor groups in activated methylene or methine, or may have at least 2 activated unsaturated acceptor groups C═C, which react with donor component (i). The crystalline component CC may also be a non-RMA reactive component (iii). Accordingly, in one embodiment at least part of the donor component (i), acceptor component (ii) and/or the non-RMA reactive component (iii) is the crystalline component CC.

In another embodiment, the crystalline component CC has a melting temperature below 140° C. preferably below 120° C., even more preferably below 110° C. or even 100° C. Preferably the crystalline component CC is present in both paint components A and B.

In yet another embodiment, the crystalline component CC has a number average molecular weight (Mn) of more than 500, 750, 1000, and less than 5000, 4000, 3000.

In a preferred embodiment crystalline component CC is present in both paint components A and B, at an amount whereby the difference of the weight fraction of the crystalline component CC in view of the weight of paint component A and paint component B, is less than 5 wt %. This way the plasticization effect due to its melting that the crystalline component CC has on both paint components, is similar. Without being bound to a theory, the diffusion increases by lowering the Tg at curing and when the diffusion coefficient of the two paint components A and B deviate too much, this will and up in a different curing speed and may result in s hazy coating.

In another embodiment, the crystalline component CC, is a polyurethane compound, preferably a polyurethane made by reacting hexamethylene diisocyanate with a isocyanate reactive group. Preferably, the isocyanate reactive group is a diol preferably selected from the group consisting of diethylene glycol; triethylene glycol; 3-methyl 1,5-pentanediol, 2-methyl 1,3-propane diol; thio diethanol; dithio diethanol; bis(hydroxyethyl)methyl amine; tetraethylene glycol; di(1,3-propanediol); di(1,4-butanediol), and is preferably diethyleneglycol or 3-methyl-1,5-pentanediol. The donor or acceptor functional groups can be introduced as end group, or a midchain moiety.

### The Separated Catalyst System

The catalyst system is a separated catalyst system that comprises the catalyst precursor (P) which is a weak base with a pKa of its protonated form of more than 2, preferably more than 3, more preferably more than 4 and even more preferably at least 5 points lower than that of the activated C—H donor groups in activated methylene or methine of crosslinkable donor component A; and the catalyst activator (C) that at cure temperature can react with P, producing a strong base (CP) able to initiate the Michael Addition reaction between (i) and (ii). The catalyst precursor composition (P) and the catalyst activator composition (C) are macrophysically separated.

In one embodiment, the activator (C) is present in an amount from 60 to 1200 meq/g, preferably 90 to 750, even more preferably 180 to 390 meq/g in view of the total weight of the catalyst system, the crosslinkable composition and if present the non-RMA reactive component (iii).

In another embodiment, precursor (P) is present in an amount from 20 to 400 meq/g, preferably 30 to 250 meq/g, more preferably 60 to 130 meq/g, in view of total weight of the catalyst system, the crosslinkable composition and if present the non-RMA reactive component (iii).

In a preferred embodiment, the catalyst system is formed by a catalyst precursor (P), a catalyst activator (C) and a catalyst retarder (T), whereby the retarder (T) is an acid that has a pKa of more than 2 points lower than that of the activated C—H of the donor component (i), and which upon deprotonation produces a weak base that can react with the catalyst activator C, producing a strong base that can catalyse the RMA reaction between the components (i) and (ii).

In one embodiment, the retarder (T) is present in an amount from 10-800, 15-500, 30-260 meq/g in view of the total weight of the catalyst system, the crosslinkable composition and if present the non-RMA reactive component (iii).

In one embodiment, the catalyst system comprises the catalyst activator (C) is preferably selected from the group of epoxide, carbodiimide, oxetane, vinyl ether, oxazoline or aziridine functional components, preferably an epoxide or carbodiimide, and comprise the catalyst precursor (P) that is preferably a weak base nucleophile anion chosen from the group carboxylate, phosphonate, sulphonate, halogenide or phenolate anions or a non-ionic nucleophile, preferably a tertiary amine or phosphine; more preferably a weak base nucleophile anion chosen from the group carboxylate, halogenide or phenolate anions or 1,4-diazabicyclo-[2.2.2]-octane (DABCO) or an N-alkylimidazole, most preferably a carboxylate.

In another embodiment the separated catalyst system comprises a catalyst precursor P which is also a Michael addition donor and a catalyst activator (C), which is a Michael acceptor comprising an activated unsaturated group C═C reactive with P. In such embodiment, in case the activator (C) is an acrylate, then (P) has a pKa of the conjugated acid below 8, preferably below 7 and more preferably below 6, wherein pKa is defined as the value in an aqueous environment, and in case (C) is a methacrylate, fumarate, itaconate or maleate, (P) has a pKa of the conjugated acid below 10.5, preferably below 9, more preferably below 8. The Michael acceptor activator (C) can be of the same type as defined as acceptor component (ii), or of a different (more reactive) nature. Within this embodiment, the catalyst precursor (P) is a weak base preferably selected from the group of phosphines, N-alkylimidazoles and fluorides or is a weak base nucleophile anion X⁻ from an acidic X—H group containing compound wherein X is N, P, O, S or C, wherein anion X⁻ is a Michael Addition donor reactive with activator (C).

A most preferred catalyst activator (C) contains an epoxy group. Suitable choices for the epoxide as preferred activator (C) are cycloaliphatic epoxides, epoxidized oils and glycidyl type epoxides. Suitable components (C) are described e.g. in U.S. Pat. No. 4,749,728 Col 3 Line 21 to 56 and include C10-18 alkylene oxides and oligomers and/or polymers having epoxide functionality including multiple epoxy functionality. Particularly suitable mono-epoxides include, tert-butyl glycidyl ether, phenyl glycidyl ether, glycidyl acetate, glycidyl esters of versatic esters, glycidyl methacrylate (GMA) and glycidyl benzoate. Useful multifunctional epoxides include bisphenol A diglycidyl ether, as well as higher homologues of such BPA epoxy resins, glycidyl ethers of hydrogenated BPA, such as Eponex 1510 (Hexion), ST-4000D (Kukdo), aliphatic oxirane such as epoxidised soybean oil, diglycidyl adipate, 1,4-diglycidyl butyl ether, glycidyl ethers of Novolac resins, glycidyl esters of diacids such as Araldite PT910 and PT912 (Huntsman), TGIC and other commercial epoxy resins. Bisphenol A diglycidyl ether, as well as its solid higher molecular weight homologues are preferred epoxides. Also useful are acrylic (co) polymers having epoxide functionality derived from glycidyl methacrylate. In a preferred embodiment, the epoxy components are oligomeric or polymeric components with an Mn of at least 400 (750, 1000, 1500). Other epoxide compounds include 2-methyl-1,2-hexene oxide, 2-phenyl-1,2-propene oxide (alpha-methyl styrene oxide), 2-phenoxy methyl-1,2-propene oxide, epoxidized unsaturated oils or fatty esters, and 1-phenyl propene oxide. Useful and preferred epoxides are glycidyl esters of a carboxylic acid, which can be on a carboxylic acid functional polymer or preferably on a highly branched hydrophobic carboxylic acid like Cardura E10P (glycidyl ester of Versatic™ Acid 10). Most preferred are typical powder crosslinker epoxy components: triglycidyl isocyanurate (TGIC), Araldite PT910 and PT912, and phenolic glycidyl ethers that are solid in nature at ambient temperature, or acrylic (co) polymers of glycidyl methacrylate.

In a preferred embodiment, the activator (C) is selected from the group of epoxide, carbodiimide, oxetane, vinyl ether, oxazoline or aziridine functional components, preferably an epoxide or carbodiimide, preferably an epoxide from the group of TGIC, GMA acrylics, other glycidyl esters, or phenolic glycidyl ethers.

Preferred examples of catalyst precursors (P) are weak base nucleophile anions chosen from the group carboxylate, phosphonate, sulphonate, halogenide or phenolate anions or salts thereof or a non-ionic nucleophile, preferably a tertiary amine or phosphine. More preferably, the weak base is a weak base nucleophile anion chosen from the group carboxylate, halogenide or phenolate salt, most preferably carboxylate salts, or it is 1,4-diazabicyclo[2.2.2]octane (DABCO), or N-alkylimidazole. The catalyst precursor (P) is able to react with catalyst activator (C), which is preferably an epoxy, to yield a strongly basic anionic adduct which is able to start the reaction of the crosslinkable components (i) and (ii). In case the retarder (T) is present it is preferably a protonated precursor (P).

Another suitable example of a catalyst precursor (P) is a weak base nucleophile anion selected from the group of weak base anion X— from an acidic X—H group containing compound wherein X is N, P, O, S or C, wherein anion X— is a Michael Addition donor reactable with a Michael acceptor activator C and anion X— is characterized by a pKa of the corresponding conjugate acid X—H below 8, preferably below 7 and more preferably below 6, wherein pKa is defined as the value in an aqueous environment, and in case C is a methacrylate, fumarate, itaconate or maleate, P has a pKa of the conjugated acid below 10.5, preferably below 9, more preferably below 8.

The catalyst precursor which is a weak base P preferably reacts with catalyst activator C at temperatures below 150° C., preferably 140, 130, 120 and preferably at least 70, preferably at least 80 or 90° C. on the time scale of the cure process. The reaction rate of weak base P with activator C at the cure temperature is sufficiently low to provide a useful open time, and sufficiently high to allow sufficient cure in the intended time window.

When the catalyst precursor P is an anion, it is preferably added as a salt comprising a cation that is not acidic. Not acidic means not having a hydrogen that competes for base with crosslinkable donor component (i), and thus not inhibiting the crosslinking reaction at the intended cure temperature. Preferably, the cation is substantially non-reactive towards any components in the crosslinkable composition. The cations can e.g. be alkali metals, quaternary ammonium or phosphonium but also protonated ‘superbases’ that are non-reactive towards any of the components (i) or (ii) in the crosslinkable composition. Suitable superbases are known in the art. Preferably, the salt comprises alkali- or earth-alkali metal, in particular lithium, sodium or potassium cation or, more preferably, a quaternary ammonium or phosphonium cation according to formula Y(R′)4, wherein Y represents N or P, and wherein each R′ can be a same or different alkyl, aryl or aralkyl group possibly linked to a polymer or wherein the cation is a protonated very strong basic amine, which very strong basic amine is preferably selected from the group of amidines; preferably 1,8-diazabicyclo(5.4.0) undec-7-ene (DBU), or guanidines; preferably 1,1,3,3-tetramethylguanidine (TMG). R′ can be substituted with substituents that do not or not substantially interfere with the RMA crosslinking chemistry as is known to the skilled person. Most preferably R′ is an alkyl having 1 to 12, most preferably 1 to 4 carbon atoms.

Optionally, in some preferred embodiments, the separated catalyst system further comprises a retarder T, which is an acid that has a pKa of 2, preferably 3, more preferably 4 and most preferably 5 points lower than that of the activated C—H in the crosslinkable donor component (i), and which upon deprotonation produces a weak base that can act as a P precursor, and can react with the activator C, to produce a strong base that can catalyze the Michael Addition reaction between (i) and (ii).

The retarder T is preferably a protonated precursor P. Preferably the retarder T and the protonated precursor P have a boiling point of at least 120° C., preferably 130° C., 150, 175, 200 or even 250° C. Preferably, retarder T is a carboxylic acid. The use of a retarder T can have beneficial effects in postponing the crosslinking reaction to allow more interdiffusion of the components during cure, before mobility limitations become significant.

In one specific embodiment, the catalyst activator C is an acrylate acceptor group and component P and T are X⁻/X—H components, preferably carboxylate/carboxylic acid compounds, having (in acid form) pKa below 8, more preferably below 7, 6 or even 5.5. Examples of useful X—H components for acrylate acceptor containing powder paint compositions include cyclic 1,3-diones as 1,3-cyclohexanedione (pKa 5.26) and dimedone (5,5-dimethyl-1,3-cyclohexanedione, pKa 5.15), ethyl trifluoroacetoacetate (7.6), Meldrum's acid (4.97). Preferably, X—H components are used that have a boiling point of at least 175° C., more preferably at least 200° C.

In another embodiment, the catalyst activator C is a methacrylate, fumarate, maleate or itaconate acceptor group, preferably methacrylate, itaconate or fumarate groups, and components P and T are X⁻/X—H components having acid pKa below 10.5, more preferably below 9.5, 8 or even below 7.

The pKa values referred to in this patent application, are aqueous pKa values at ambient conditions (21° C.). They can be readily found in literature and if needed, determined in aqueous solution by procedures known to those skilled in the art.

To be able to provide a helpful delay of the crosslinking reaction under cure conditions, the reaction of the retarder T and its deprotonated version P with activator C should take place with a suitable rate.

A preferred separated catalyst system comprises as catalyst activator C an epoxy, as catalyst precursor P a weak base nucleophilic anion group that reacts with the epoxide group of C to form a strongly basic adduct C, and most preferably also a retarder T. In a suitable separated catalyst system, P is a carboxylate salt and C is epoxide, carbodiimide, oxetane, vinyl ether or oxazoline, more preferably an epoxide or carbodiimide, and T is a carboxylic acid. Alternatively P is DABCO, C is an epoxy, and T is a carboxylic acid.

Without wishing to be bound to a theory it is believed that the nucleophilic anion P reacts with the activator epoxide C to give a strong base, but that this strong base is immediately protonated by the retarder T to create a salt (similar in function to P) that will not directly strongly catalyse the crosslinking reaction. The reaction scheme takes place until substantially complete depletion of the retarder T, which provides for the open time because no significant amount of strong base is present during that time to significantly catalyse the reaction of the crosslinkable components (i) and (ii). When the retarder T is depleted, a strong base will be formed and survive to effectively catalyse the rapid RMA crosslinking reaction.

In one embodiment retarder T is a protonated anion group P, preferably carboxylic acid T and carboxylate P, which for example can be formed by partially neutralising an acid functional component, preferably a polymer comprising acid groups as retarder T to partially convert to anionic groups on P, wherein the partial neutralizing is done preferably by a cation hydroxide or (bi) carbonate, preferably tetraalkylammonium or tetraalkylphosphonium cations. In another embodiment, a polymer bound component P can be made by hydrolysis of an ester group in a polyester with aforementioned hydroxides.

It is preferred that the boiling point of the component T and of the conjugate acid of P are above the envisaged curing temperature of the powder coating composition AB to prevent less well controlled evaporation of these catalyst system components during curing conditions. Formic acid and acetic acid are less preferred retarders T as they may evaporate during curing. Preferably, retarder T and the conjugate acid of P have a boiling point higher than 120° C.

Although less preferred, it is possible that at least one of the components P, C, or T of the separated catalyst system is a group on one of the crosslinkable components (i) or (ii) or both. In that case it must be ensured that P and C are macrophysically separated in the two component powder coating composition AB. It is possible that one or more but not all groups of P, C and T are on RMA crosslinkable components (i) or (ii) or both. In a convenient embodiment both P and T are on the RMA crosslinkable component (i) and/or (ii) and P is preferably formed by partially neutralising an acid functional polymer comprising acid groups of T with a base comprising a cation as described above to partially convert acid groups on T to anionic groups on P. Another embodiment would have component P formed by hydrolysis of a polyester, e.g. of a polyester of component (i), and be present as a polymeric species.

The powder coating composition AB preferably comprises in case of a separated catalyst system
a. an activator C in an amount between 1 and 600 μeq/gr, preferably between 10 and 400, more preferably between 20 and 200 μeq/gr, wherein μeq/gr is μeq relative to total weight of binder components (i) and (ii) and the separated catalyst system,
b. a precursor that is a weak base P in an amount between 1 and 300 μeq/gr, preferably between 10 and 200, more preferably between 20 and 100 μeq/gr relative to total weight of binder components (i) and (ii) and separated catalyst system,
c. optionally a retarder T in an amount between 1 and 500, preferably between 10 and 400, more preferably between 20 and 300 μeq/gr and most preferably between 30 and 200 μeq/gr,
d, wherein preferably the equivalent amount of C
i. is higher than the equivalent amount of T, preferably by an amount between 1 and 300 μeq/gr, preferably between 10 and 200, more preferably between 20 and 100 μeq/gr and
ii. is preferably higher than the equivalent amount of P and
iii. is preferably higher than the sum of the equivalent amount of P and T.

However, in case whereby the activator C is a Michael acceptor comprising an activated unsaturated group C═C reactive with P, there is no relevant upper limit in concentration as in this case C may be also component (ii).

It is also possible that the separated catalyst system works with the amount of C being lower than of P. However, this is less preferred as it will leave unreacted P. In case the amount of C, in particular epoxide, is higher than the amount of P the drawbacks are limited as it may react with P and T or other nucleophilic remains, but still maintain basicity after reaction or it may be left in the network, without too much problems. Nevertheless, excess of C may be disadvantageous in view of cost for C other than epoxy.

Further, it is preferred that in the powder coating composition AB
a. the precursor P represents between 10 and 100 equivalent % of the sum of P and T,
b. preferably the amount of retarder T is 20-400 eq %, preferably 30-300 eq % of the amount of P,
c. wherein preferably the ratio of the equivalent of C to the sum of the equivalent of P and T is at least 0.5, preferably at least 0.8, more preferably at least 1 and preferably at most 3, more preferably at most 2,
d. the ratio of the equivalent of C to T is preferably at least 1, preferably at least 1.5, most preferably at least 2.

In one embodiment the RMA crosslinkable composition comprises a polymer and its use as a latent base catalyst component in RMA crosslinkable coating compositions, said polymer comprising a catalyst precursor groups P and optionally acid groups T, wherein P groups are preferably formed by partially or fully neutralizing acid groups T on the polymer, wherein P and T are preferably carboxylate and carboxylic acid groups, wherein the polymer is preferably chosen from the group of acrylic, polyester, polyester-amide and polyester-urethane polymers, wherein the polymer optionally comprises C—H donor groups, C═C acceptor groups or both, wherein the polymer preferably has
a) an acid value in non-neutralized form of at least 3, more preferably 5, 7, 10, 15 or even 20 mg KOH/g, and preferably less than 100, 80, 70, 60 mg KOH/g,
b) a quaternary ammonium or phosphonium cation, preferably a tetrabutyl- or ethylammonium cation
c) an Mn at least 500, preferably at least 1000 or even 2000, and Mw no more than 20,000, preferably no more than 10,000 or 6000,
d) in case C—H donor and/or C═C acceptor groups are present; a reactive C—H donor or C═C acceptor equivalent weight of at least 150, preferably at least 250, 350 or even 450 g/mol and no more than 2000, preferably no more than 1500, 1200 or 1000 g/mol.

### Crosslinkable Components (i) and (ii)

The two component powder coating composition AB further comprises the crosslinkable composition comprising formed by a crosslinkable donor component (i) and a crosslinkable acceptor component (ii) that are crosslinkable by a Real Michael Addition (RMA) reaction, wherein
a) the crosslinkable donor component (i) has at least 2 acidic C—H donor groups in activated methylene or methine, and
b) the crosslinkable acceptor component (ii) has at least 2 activated unsaturated acceptor groups C═C, which react with component (i) by Real Michael Addition (RMA) to form a crosslinked network.

In a preferred embodiment at least one of crosslinkable components (i) or (ii) is a polymer, preferably chosen from the group of acrylic, polyester, polyester amide, polyester-urethane polymers, which polymer
has a number average molecular weight Mn, as determined with GPC, of at least 450 g/mole, preferably at least 1000, more preferably at least 1500 and most preferably at least 2000 g/mole;
has a weight average molecular weight Mw, as determined with GPC, of at most 20000 g/mole, preferably at most 15000, more preferably at most 10000 and most preferably at most 7500 g/mole;
preferably has a polydispersity Mw/Mn below 4, more preferably below 3;
has an equivalent weight EQW in C—H or C═C of at least 150, 250, 350, 450 or 550 g/mole and preferably at most 2500, 2000, 1500, 1250 or 1000 g/mole and a number average functionality of reactive groups C—H or C═C between 1-25, more preferably 1.5-15 even more preferably 2-15, most preferably 2.5-10 C—H groups per molecule;
preferably has a melt viscosity at a temperature in the range between 10° and 140° C. less than 60 Pas, more preferably less than 40, 30, 20, 10 or even 5 Pas;
preferably comprises amide, urea or urethane bonds and/or comprises high Tg monomers, preferably cycloaliphatic or aromatic monomers, in particular polyester monomers chosen from the group of 1,4-dimethylol cyclohexane (CHDM), tricyclodecanedimethanol (TCD diol), isosorbide, penta-spiroglycol or hydrogenated bisphenol A and tetramethyl-cyclobutanediol; and/or
has a Tg above 25° C., preferably above 35° C., more preferably above 40, 50 or even 60° C. as the midpoint value determined by DSC at a heating rate of 10° C./min or is a crystalline polymer with a melting temperature between 40° C. and 150, preferably 130° C., preferably at least 50 or even 70° C. and preferably lower than 120° C. (as determined by DSC at a heating rate of 10° C./min).

Preferably, the crosslinkable component (i) comprises at least 2 acidic C—H donor groups in activated methylene or methine in a structure Z1(—C(—H)(—R)—)Z2 wherein R is hydrogen, a hydrocarbon, an oligomer or a polymer, and wherein Z1 and Z2 are the same or different electron-withdrawing groups, preferably chosen from keto, ester or cyano or aryl groups, and preferably comprises an activated C—H derivative having a structure according to formula 1:

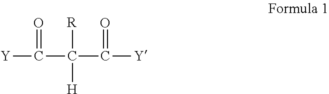

wherein R is hydrogen or an optionally substituted alkyl or aryl and Y and Y′ are identical or different substituent groups, preferably alkyl, aralkyl or aryl, or alkoxy or wherein in formula 1 the —C(═O)—Y and/or —C(═O)—Y′ is replaced by CN or aryl, no more than one aryl or wherein Y or Y′ can be NRR′ (R and R′ are H or optionally substituted alkyl) but preferably not both, wherein R, Y or Y′ optionally provide connection to an oligomer or polymer, said component (i) preferably being malonate, acetoacetate, malonamide, acetoacetamide or cyanoacetate groups, preferably providing at least 50, preferably 60, 70 or even 80% of the total of C—H acidic groups in crosslinkable component (i).

The acceptor component (ii) comprises at least 2 activated unsaturated RMA acceptor groups that preferably originate from acryloyl, methacryloyl, itaconates, maleate or fumarate functional groups,

Preferably at least one, more preferably both, of components (i) or (ii) is a polymer

Preferably, the crosslinkable composition comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

Real Michael Addition (RMA) crosslinkable coating compositions comprising crosslinkable components (i) and (ii) are generally described for use in solvent borne systems in EP2556108, EP0808860 or EP1593727 which specific description for crosslinkable components (i) and (ii) are herewith considered to be enclosed.

The components (i) and (ii) respectively comprise the RMA reactive donor and acceptor moieties which on curing react to form the crosslinked network in the coating. The components (i) and (ii) can be present on separate molecules but can also be present on one molecule, referred to as a hybrid (i)/(ii) component, or combinations thereof.

Preferably, components (i) and (ii) are separate molecules and each independently in the form of polymers, oligomers, dimers or monomers. For coating applications, it is preferred at least one of component (i) or (ii) preferably are oligomers or polymers. It is noted that an activated methylene group CH2 comprises 2 C—H acidic groups. Even though, after reaction of the first C—H acidic group, the reaction of the second C—H acid group is more difficult, e.g. for reaction with methacrylates, as compared to acrylates, the functionality of such activated methylene group is counted as 2. The reactive components (i) and (ii) can also be combined in one (i)/(ii) hybrid molecule. In this embodiment of the powder coating composition AB both C—H and C═C reactive groups are present in one (i)/(ii) molecule.

Preferably, component (i) is a polymer, preferably a polyester, polyurethane, acrylic, epoxy or polycarbonate, having as a functional group a component (i) and optionally one or more components B, or components from catalytic system C. Also, mixtures or hybrids of these polymer types are possible. Suitably component (i) is a polymer chosen from the group of acrylic, polyester, polyester amide, polyester-urethane polymers.

Malonates or acetoacetates are preferred donor types in component (i). In view of high reactivity and durability in a most preferred embodiment of the crosslinkable composition, component (i) is a malonate C—H containing compound. It is preferred that in the powder coating composition AB the majority of the activated C—H groups are from malonate, that is more than 50%, preferably more than 60%, more preferably more than 70%, most preferably more than 80% of all activated C—H groups in the powder coating composition AB are from malonate.

Preferred are oligomeric and/or polymeric malonate group-containing components such as, for example, polyesters, polyurethanes, polyacrylates, epoxy resins, polyamides and polyvinyl resins or hybrids thereof containing malonate type groups in the main chain, pendant or both.

The total amount of donor groups C—H and acceptor groups C═C per gram binder solids, independent of how they are distributed over the various crosslinkable components, is preferably between 0.05 to 6 meq/gr, more typically 0.10 to 4 meq/gr, even more preferably 0.25 to 3 meq/gr binder solids, most preferably between 0.5 to 2 meq/gr. Preferably, the stoichiometry between components (i) and (ii) is chosen such that the ratio of reactive C═C groups to reactive C—H groups is more than 0.1, preferably more than 0.2, more preferably more than 0.3, most preferably more than 0.4, and, in the case of acrylate functional groups preferably more than 0.5 and most preferably more than 0.75, and the ratio is preferably less than 10, preferably 5, more preferably less than 3, 2 or 1.5.

The malonate group-containing polyesters can be obtained preferably by the transesterification of a methyl or ethyl diester of malonic acid, with multifunctional alcohols that can be of a polymeric or oligomeric nature but can also be incorporated through a Michael Addition reaction with other components. Especially preferred malonate group-containing components for use with the present invention are the malonate group-containing oligomeric or polymeric esters, ethers, urethanes and epoxy esters and hybrids thereof, for example polyester-urethanes, containing 1-50, more preferably 2-10, malonate groups per molecule. Polymer components (i) can also be made in known manners, for example by radical polymerisation of ethylenically unsaturated monomers comprising monomers, for example (meth)acrylate, functionalised with a moiety comprising activated C—H acid (donor) groups, preferably an acetoacetate or malonate group, in particular 2-(methacryloyloxy)ethyl acetoacetate or -malonate. In practice polyesters, polyamides and polyurethanes (and hybrids of these) are preferred. It is also preferred that such malonate group containing components have a number average molecular weight (Mn) in the range of from about 100 to about 10000, preferably 500-5000, most preferably 1000-4000; and a Mw less than 20000, preferably less than 10000, most preferably less than 6000 (expressed in GPC polystyrene equivalents).

Suitable crosslinkable acceptor components (ii) generally can be ethylenically unsaturated components in which the carbon-carbon double bond is activated by an electron-withdrawing group, e.g. a carbonyl group in the alpha-position. Representative examples of such components are disclosed in U.S. Pat. No. 2,759,913 (column 6, line 35 through column 7, line 45), DE-PS-835809 (column 3, lines 16-41), U.S. Pat. No. 4,871,822 (column 2, line 14 through column 4, line 14), U.S. Pat. No. 4,602,061 (column 3, line 14 20 through column 4, line 14), U.S. Pat. No. 4,408,018 (column 2, lines 19-68) and U.S. Pat. No. 4,217,396 (column 1, line 60 through column 2, line 64).

Acrylates, methacrylates, itaconates, fumarates and maleates are preferred. Itaconates, fumarates and maleates can be incorporated in the backbone of a polyester or polyester-urethane. Preferred example resins such as polyesters, polycarbonates, polyurethanes, polyamides, acrylics and epoxy resins (or hybrids thereof) polyethers and/or alkyd resins containing activated unsaturated groups may be mentioned. These include, for example, urethane (meth)acrylates obtained by reaction of a polyisocyanate with an hydroxyl group containing (meth)acrylic ester, e.g., an hydroxy-alkyl ester of (meth)acrylic acid or a component prepared by esterification of a poly-hydroxyl component with less than a stoichiometric amount of (meth)acrylic acid; polyether (meth)acrylates obtained by esterification of an hydroxyl group-containing polyether with (meth)acrylic acid; poly-functional (meth)acrylates obtained by reaction of an hydroxy-alkyl (meth)acrylate with a poly-carboxylic acid and/or a poly-amino resin; poly(meth)acrylates obtained by reaction of (meth)acrylic acid with an epoxy resin, and poly-alkyl maleates obtained by reaction of a mono-alkyl maleate ester with an epoxy resin and/or an hydroxy functional oligomer or polymer. Also, polyesters end-capped with glycidyl methacrylate are a preferred example. It is possible that the acceptor component contains multiple types of acceptor functional groups.

Most preferred activated unsaturated group-containing acceptor components (ii) are the unsaturated acryloyl, methacryloyl and fumarate functional components. Preferably the number average functionality of activated C═C groups per molecule is 2-20, more preferably 2-10, most preferably 3-6. The equivalent weight (EQW: average molecular weight per reactive functional group) is 100-5000, more preferable 200-2000, and the number average molecular weight preferably is Mn 200-10000, more preferable 300-5000, most preferably 400-3500 g/mole, even more preferably 1000-3000 g/mole.

In view of the use in powder systems the Tg of the acceptor component (ii) is preferably above 25, 30, 35, more preferably at least 40, 45, most preferably at least 50° C. or even at least 60° C., because of the need for powder stability. The Tg is defined as measured with DSC, mid-point, heating rate 10° C./min. If one of the components has a Tg substantially higher than 50° C., the Tg of the other formulation components can be lower as will be understood by those skilled in the art. A suitable acceptor component (ii) is a urethane (meth)acrylate which has been prepared by reacting a hydroxy- and (meth)acrylate functional compound with isocyanate to form urethane bonds, wherein the isocyanates are preferably at least in part di- or tri-isocyanates, preferably isophorone diisocyanate (IPDI). The urethane bonds introduce stiffness on their own but preferably high Tg isocyanates are used like cyclo-aliphatic or aromatic isocyanates, preferably cycloaliphatic. The amount of such isocyanates used is preferably chosen such that said (meth)acrylate functional polymer Tg is raised above 40, preferably above 45 or 50° C.

The powder coating composition AB is designed preferably in such a way, that after cure, a crosslink density (using DMTA) can be determined of at least 0.025 mmole/cc, more preferably at least 0.05 mmole/cc, most preferably at least 0.08 mmole/cc. and typically less than 3, 2, 1 or 0.7 mmole/cc.

The powder coating composition AB should retain free flowing powder at ambient conditions and therefore preferably has a Tg above 25° C., preferably above 30° C., more preferably above 35, 40, 50° C. as the midpoint value determined by DSC at a heating rate of 10° C./min.

As described above the preferred component (i) is a malonate functional component. However, incorporation of malonate moieties tends to reduce the Tg and it has been a challenge to provide powder coating compositions AB based on malonate as the dominant component (i) with sufficiently high Tg.

In view of achieving high Tg, the powder coating composition AB preferably comprises a crosslinkable composition of which crosslinkable donor component (i) and/or the crosslinkable acceptor component B, which may be in the form of a hybrid component A/B, comprises amide, urea or urethane bonds and/or whereby the crosslinkable composition comprises high Tg monomers, preferably cycloaliphatic or aromatic monomers or in case of polyesters, one or more monomers chosen from the group of 1,4-dimethylol cyclohexane (CHDM), tricyclodecanedimethanol (TCD diol), isosorbide, penta-spiroglycol, hydrogenated bisphenol (i) and tetra-methyl-cyclobutanediol.

Further, in view of achieving high Tg, the powder coating composition AB comprises component (ii) or hybrid component (i)/(ii) being a polyester (meth-)acrylate, a polyester urethane (meth-)acrylate, an epoxy (meth-)acrylate or a urethane (meth-)acrylate, or is a polyester comprising fumarate, maleate or itaconate units, preferably fumarate or is a polyester end-capped with isocyanate or epoxy functional activated unsaturated group.

The polymer features Mn, Mw and Mw/Mn are chosen in view of on one hand the desired powder stability and on the other hand the desired low melt viscosity, but also the envisaged coating properties. A high Mn is preferred to minimize Tg reduction effects of end groups, on the other hand low Mw's are preferred because melt viscosity is very much related to Mw and a low viscosity is desired; therefore low Mw/Mn is preferred.

In view of achieving high Tg the RMA crosslinkable polymer preferably comprises amide, urea or urethane bonds and/or comprising high Tg monomers, preferably cycloaliphatic or aromatic monomers, or in case of polyesters comprises monomers chosen from the group of 1,4-dimethylol cyclohexane (CHDM), TCD diol, isosorbide, penta-spiroglycol or hydrogenated bisphenol A and tetramethyl-cyclobutanediol.

In case the RMA crosslinkable polymer is an (i)/(ii) hybrid polymer it is further preferred that the polymer also comprises one or more component (ii) groups chosen from the group of acrylate or methacrylate, fumarate, maleate and itaconate, preferably (meth)acrylate or fumarate. Further, if to be used as crystalline material, it is preferred that the RMA crosslinkable polymer has crystallinity with a melting temperature between 40° C. and 130° C., preferably at least 50 or even 70° C. and preferably lower than 150, 130 or even 120° C. (as determined by DSC at a heating rate of 10° C./min) It is noted that this is the melting temperature of the (pure) polymer itself and not of the polymer in a blend

In a preferred embodiment the RMA crosslinkable polymer comprising polyester, polyester amide, polyester-urethane or a urethane-acrylate which comprises urea, urethane or amide bonds derived from cycloaliphatic or aromatic isocyanates, preferably cycloaliphatic isocyanates, said polymer having a Tg of at least 40° C., preferably at least 45 or 50° C. and at most 120° C. and a number average molecular weight Mn of 450-10000, preferably 1000-3500 gr/mole and preferably a maximum Mw of 20000, 10000 or 6000 gr/mole and which polymer is provided with RMA crosslinkable components (i) or (ii) or both. The polymer is obtainable for example by reacting a precursor polymer comprising said RMA crosslinkable groups with an amount of cycloaliphatic or aromatic isocyanates to increase the Tg. The amount of such isocyanates added, or urea/urethane bonds formed, is chosen such the Tg is raised to at least 40° C., preferably at least 45 or 50° C.

Preferably, the RMA crosslinkable polymer is a polyester or polyester-urethane comprising a malonate as the dominant component (i) and comprising a number average malonate functionality of between 1-25, more preferably 1.5-15 even more preferably 2-15, most preferably 2.5-10 malonate groups per molecule, has a GPC weight average molecular weight between 500 and 20000, preferably 1000-10000, most preferably 2000-6000 gr/mole, which has been prepared by reacting a hydroxy- and malonate functional polymer with isocyanate to form urethane bonds. Further, the polymer can be an amorphous or crystalline polymer or a mixture thereof. Crystallinity is to be defined by DSC melting endotherms, targeted crystallinity defined as having a DSC peak melting temperature Tm at least 40° C., preferably at least 50° C., more preferably at least 60° C. and preferably at most 130, 120, 110 or 100° C. The DSC Tg of such a component in fully amorphous state preferably is below 40° C., more preferably below 30, 20 or even 10° C.

Non-RMA Reactive Component (iii) and Further Components

The powder coating composition AB may further comprise a non-RMA reactive component (iii). The component (iii) may be a crystalline compound CC, such as any type of crystalline components that is typically used in powder coating resins. Examples are, crystalline or semi-crystalline polyester resins.

Further examples are polyurethane compounds, preferably a polyurethane made by reacting hexamethylene diisocyanate with a isocyanate reactive group, and preferably has a Mn of more than 500, 750, 1000, and less than 5000, 4000, 3000. The isocyanate reactive group can be a diol and is preferably selected from the group consisting of diethylene glycol; triethylene glycol; 3-methyl 1,5-pentanediol, 2-methyl 1,3-propane diol; thio diethanol; dithio diethanol; bis(hydroxyethyl)methyl amine; tetraethylene glycol; di(1,3-propanediol); di(1,4-butanediol), preferably diethyleneglycol or 3-methylpentanediol.

The non-RMA reactive components (iii) may also be additives, which are known in the prior art. In case the additives are crystalline, these compounds can be considered as crystalline compound CC according to the invention. Without claiming to be a complete list, the additives which may be used are levelling agents, anti-crater additives, texturizing agents, degassing agents, antioxidants, UV absorbers, (tribo-) charge control substances, anti-blocking additives (for example waxes to improve the stability upon storage), fluidization agents, flame retardants, IR absorbers and additives for improving the surface properties (such as, for example, hardness, abrasion resistance, scratch resistance, chemical resistance, over-painting capability, adhesion, surface tension, and substrate wetting).

The powder coating composition may also comprise pigments and/or fillers. These are not considered as non-RMA reactive component (iii), since these components may not be taken into account when calculation the amount of crystalline component present in the coating composition AB or when calculating the maximum plasticization effect due to melting of the crystalline component CC. This is because pigments and fillers form a separate phase and will not mix with the other components at melting.

### Substrate and Coating

The invention also relates to a method for powder-coating a substrate comprising
a. applying a layer of the powder coating composition AB to a substrate surface and
b. heating to a curing temperature Tcur between 75 and 150° C., preferably between 8° and 150° C. and more preferably between 80 and 140, 130 or 120° C., optionally and preferably using infrared heating,
c. and curing at Tcur for a curing time preferably less than 40, 30, 20, 15, 10 or even 5 minutes.

In the method the curing at Tcur is preferably characterised by a curing profile, as determined by measuring the conversion of the unsaturated bonds C═C of component (ii) as a function of time by FTIR wherein the ratio of the time to go from 20% to 60% C═C conversion to the time to reach 20% conversion is less than 1, preferably less than 0.8, 0.6, 0.4 or 0.3, preferably with the time to reach 60% conversion being less than 30 or 20 or 10 min and the powder coating composition at the Tcur preferably has a melt viscosity at the curing temperature less than 60 Pas, more preferably less than 40, 30, 20, 10 or even 5 Pas. The melt viscosity is to be measured at the very onset of the reaction or without C2 of the catalysis system.

In a preferred embodiment of the method the curing temperature is between 75 and 140° C., preferably between 8° and 120° C. and the catalyst system C is a latent catalyst system as described above which allows for powder coating a temperature sensitive substrate, preferably MDF, wood, plastic or temperature sensitive metal substrates like alloys.

Due to the dead matting effect of the two component powder coating composition AB the articles may have a gloss level that is less than 20GU at 60° angle.

Therefore, the invention also relates to articles coated with a powder coating composition of the invention, preferably having a temperature sensitive substrate like MDF, wood, plastic or metal alloys and wherein preferably the crosslinking density XLD of the coating is at least 0.01, preferably at least 0.02, 0.04, 0.07 or even 0.1 mmole/cc (as determined by DMTA) and is preferably lower than 3, 2, 1.5, 1 or even 0.7 mmole/cc.

The invention will be illustrated by the following examples.

### Test Methods

### Acid Value

A freshly prepared solvent blend of 1:1 xylene:ethanol is prepared. A quantity of resin is accurately weighed out into a 250 ml conical flask. 50-60 ml of 1:1 xylene:ethanol is then added. The solution is heated gently until the resin is entirely dissolved, and ensuring the solution does not boil. The solution is then cooled to room temperature and a potentiometric titration was conducted with 0.1 M potassium hydroxide until after the equivalence point.

### OH Value

The OHV was determined by manual titration of the prepared blanks and sample flasks. The indicator solution is made up by dissolving 0.80 g of Thymol Blue and 0.25 g of Cresol Red in 1 L of methanol. 10 drops of indicator solution is added to the flask which is then titrated with the standardized 0.5N methanolic potassium hydroxide solution. The end point is reached when the color changes from yellow to grey to blue and gives a blue coloration which is maintained for 10 seconds. The hydroxy value is then calculated according to:

Hydroxy Value=(B−S)×N×56.1/M+AV
Where:
B=ml of KOH used for blank titration
S=ml of KOH used for sample titration
N=normality of potassium hydroxide solution
M=sample weight (base resin)
AV=Acid Value of the base resin

The Net Hydroxy Value is defined as: Net OHV=(B−S)×N×56. 1/M

### Amine Value

A freshly prepared solvent blend of 3:1 xylene:ethanol propanol is prepared. A quantity of resin is accurately weighed out into a 250 ml conical flask. 50-60 ml of 3:1 xylene:ethanol is then added. The solution is heated gently until the resin is entirely dissolved, and ensuring the solution does not boil. The solution is then cooled to room temperature and a potentiometric titration was conducted with 0.1 M hydrochloride acid until after the equivalence point.

### GPC Molecular Weight

Molar mass distribution of polymers was determined with Gel Permeation Chromatography (GPC) on Perkin-Elmer HPLC series 200 equipment, using refractive index (RI) detector and PLgel column, using as eluens THF, using calibration by polystyrene standards. Experimental molecular weights are expressed as polystyrene equivalents.

### DSC Tg

The glass transition temperatures of the paint components are the mid-point Tgs determined from Differential Scanning calorimetry (DSC) using a heating rate of 10° C./min. The glass transition temperatures of the individual components are determined by DSC in a program whereby the sample was heated and cooled between-30 and 150° C./min, starting from −30° C. The mid-point Tgs of 1^{st} cooling stage and 2ed heating stage were reported for amorphous materials. The mid-point Tgs of 1^{st} cooling stage were reported for (semi)crystalline materials.

### Dry Film Thickness (DFT)

Dry film thicknesses (DFT) were measured using Positector 6000 Coating Thickness Gauges.

### Gloss at (60°)

The gloss of the coatings is measured using Zehntner ZGM 1130 gloss meter.

### Abbreviations

TABLE 1
description of the abbreviations used in the examples.

| | |
|---|---|
| NPG | neopentyl glycol |
| IPA | isophthalic acid |
| TPA | terephthalic acid |
| GMA | glycidyl methacrylate |
| IPDI | isophorone diisocyanate |
| TEAHCO₃ | tetraethylammonium bicarbonate |
| AV | acid value |
| OHV | hydroxyl value |
| Wt % | weight percent |
| Mn | number average molecular weight |
| Mw | weight average molecular weight |
| Tg | glass transition Temperature |
| EQW | equivalent weight |

| | | |
|---|---|---|
| Araldite ® PT 810 | triglycidyl isocyanurate TGIC (ex | Epoxy EQW is 101; DSC Tg in |
| | Huntsman) | the 1^{st} cooling stage is −5° C. |
| Almatex ™ PD-3402 | GMA-acrylic resin (ex Anderson) | epoxy EQW is 380; DSC Tg in |
| | | the 1^{st} cooling stage and 2^{ed} |
| | | heating stage are 47° C. and 51° |
| | | C., respectively |
| MODAFLOW ® | powder coating flow modifiers on | |
| P6000 | silica carrier (ex Allnex) | |
| Ken-React ® KR46B | titanium (IV) tetrakis octanolato | |
| | adduct 2 moles (di-tridecyl)hydrogen | |
| | phosphite (Kenrich petrochemicals, | |
| | Inc) | |

### Preparation of Materials

### Preparation of Malonate Donor Resin

A 5 litre round bottom reactor equipped with a 4 necked lid, metal anchor stirrer, Pt-100, packed column with top thermometer, condenser, distillate collection vessel, thermocouple and a N2 inlet was charged with 1300 g isosorbide (80%), 950 g NPG and 1983 g TPA. The temperature of the reactor was gently raised to about 100° C., and 4.5 g of Ken-React® KR46B catalyst was added. The reaction temperature was further increased gradually to 230° C., and the polymerization was progressed under nitrogen with continuous stirring until the reaction mixture is clear and the acid value is below 2 mg KOH/g. During the last part of the reaction, vacuum was applied to push the reaction to completion. The temperature was lowered to 120° C., and 660 g of diethylmalonate was added. The temperature of the reactor was then increased to 190° C. and maintained until no more ethanol was formed. Again, vacuum was applied to push the reaction to completion. After the transesterification was completed, the hydroxyl value of the polyester was measured. The final OHV was 27 mg KOH/g, with a GPC Mn of 1763 and a Mw of 5038. The Tg determined in the 1^{st} cooling and 2^{ed} heating stage are 59° C. and 63° C., respectively.

### Preparation of Urethane Acrylate Acceptor Resin

A urethane-acrylate based on IPDI, hydroxy-propyl-acrylate, glycerol is prepared with the addition of suitable polymerization inhibitors, as described in e.g EP0585742. In a 5 litre reactor equipped with thermometer, stirrer, dosing funnel and gas bubbling inlet, 1020 parts of IPDI, 1.30 parts of di-butyl-tin-dilaurate and 4.00 parts of hydroquinone are loaded. Then 585 parts of hydroxypropylacrylate are dosed, avoiding that temperature increases to more than 50° C. Once addition is completed, 154 parts of glycerine are added. 15 minutes after the exothermic reaction subsides, the reaction product is cast on a metallic tray. The resulting urethane-acrylate is characterized by a GPC Mn of 744 and Mw of 1467, residual isocyanate content <0.1%, and theoretical unsaturation EQW of 394 g/mol. The Tg determined in the 1^{st} cooling and 2^{ed} heating stage are 46° C. and 51° C., respectively.

### Preparation of Crystalline Urethane Acrylate Resin CUA-1

Similarly, 504.6 g HDI, 0.1 g DBTL and 5 g BHT were charged into a 2 liter round bottom reactor and heated to 50° C. under dry air. A mixture of 232.2 g hydroxyethyl acylate and 236.3 g 3-methyl-1,5-pentanediol was then added drop-wisely into the reactor to start the reaction, and the process temperature was kept below 120° C. The (semi)crystalline urethane acrylate CUA-1 obtained has a max and an end DSC melting temperature of 95° C. and 102° C., respectively. The theoretical Mn=973 and unsaturation EQW=487 g/mol. The Tg determined in the 1^{st} cooling stage is −20° C.

### Preparation of Crystalline Urethane Acrylate Resin CUA-2

504.6 g HDI, 0.1 g DBTL and 5 g BHT were charged into a 2 liter round bottom reactor and heated to 50° C. under dry air. A mixture of 288.3 g hydroxybutyl acylate and 212.2 g diethylene glycol was then added drop-wisely into the reactor to start the reaction, and the process temperature was kept below 120° C. The (semi)crystalline urethane acrylate CUA-2 obtained has a max and an end DSC melting temperature of 106° C. and 115° C. respectively. The theoretical Mn=1005 and unsaturation EQW=506 g/mol. The Tg determined in the 1^{st} cooling stage is −7.5° C.

### Preparation of Carboxylate Terminated Retarder Resin

A 5 liter round bottom reactor equipped with a 4 necked lid, metal anchor stirrer, Pt-100, packed column with top thermometer, condenser, distillate collection vessel, thermocouple and a N2 inlet was charged with 1180 g NPG and 2000 g IPA. The temperature of the reactor was increased to 230° C., and the polymerization was progressed under nitrogen with continuous stirring until the reaction mixture is clear. The final product obtained has AV of 48 mg KOH/g. The Tg determined in the 1^{st} cooling and 2^{ed} heating stage are 52° C. and 55° C., respectively.

### Preparation of Catalyst Precursor

To prepare the catalyst precursor, a carboxylate terminated polyester resin (AV of 48) was melted and mixed with an aqueous solution of tetraethylammonium bicarbonate TEAHCO₃ (41%) using a Leistritz ZSE 18 twin-screw extruder. The extruder comprised a barrel housing nine consecutive heating zones, that were set to maintain the following temperature profile 30-50-80-120-120-120-120-100-100 (in ° C.) from inlet to outlet. The solid polyester resin was added through first zone at a rate 2 kg/h, and liquid TEAHCO₃ was injected through second zone at 0.60 kg/h. Mixing was taken place between zone 4 to 7 and the screw was set to rotate at 200 rpm. Volatiles and water generated from acid-base neutralization was removed with assistance of vacuum at zone 7. The extruded strand was immediately cooled and collected after leaving the die. The final product obtained has AV of 11 mg KOH/g, amine value of 33 KOH/g. The Tg determined in the 1^{st} cooling and 2^{ed} heating stage are 42° C. and 48° C., respectively.

### Preparation of Activator Based on Glycidyl Methacrylate AMSD-GMA Acrylic

189 g α-methyl styrene dimer (AMSD) was charged into a 2 liter round bottom reactor and heated up to 140° C. 641 g methyl methacrylate, 284 g glycidyl methacrylate and 19.5 g Trigonox® 121 were mixed in a separate flask, and then drop wisely added into the reactor to start the reaction. The addition was completed in 6 hours and the process temperature was kept at 140-145° C. After that, the reaction was left to proceed further at 140° C. for another hour. At end, additional 1.9 g Trigonox® 121 was added into the reactor in 30 minutes. Finally, the residue monomers were removed by distillation under vacuum. The AMSD-GMA obtained has a theoretical Mn=1114 and an epoxy EQW=557. The Tg determined in the 1^{st} cooling and 2^{ed} heating stage are 43° C. and 46° C., respectively.

### Powder Coating Compositions and Powder Coating Component Compositions Preparations

To prepare the powder coating composition (PW1) or powder coating components (PWC2-10), the raw materials were first premixed in a high speed Thermoprism Pilot Mixer 3 premixer at 1500 rpm for 20 seconds before being extruded in a Baker Perkins (formerly APV) MP19 25:1 L D twin screw extruder. Following extrusion, the extrudates were grounded using a Kemutec laboratory classifying microniser. The classifier was set at 5.5 rpm, the rotor was set at 7 rpm and the feed was set at 5.2 rpm. The extruder speed was 250 rpm and the four extruder barrel zone temperatures were set at 25, 60, 100 and 100° C. The grounded extrudates were sieved to below 100 μm using Russel Finex 100-micron mesh Demi Finex laboratory vibrating sieves. Formulation compositions (as parts by weight) for PW1, PWC2-PWC3, PWC4-PWC7 and PWC8-PWC10 are given in Table 1, 2, 4 and 6 respectively.

### Results

PW1 is a comparative example of powder coating whereby all the compounds as listed in Table 1 were extruded together. The amount of crystalline component (e.g. CUA-1) is 18.7 wt %, and this correspond to a maximum plasticization of 16.5° C.

TABLE 1
Comparative powder coating PW1.

| Comparative powder coating compositions (values in parts by | |
|---|---|
| weight) | PW1 |
| Malonate donor M-1 | 337 |
| Crystalline urethane-acrylate acceptor CUA-1 | 148 |
| Urethane-acrylate acceptor | 120 |
| Catalyst precursor | 87 |
| Retarder resin | 10 |
| Almatex ™ PD-3402 | 88 |
| Titanium dioxide Kronos ® 2160 | 200 |
| Modaflow P6000 | 10 |
| Total | 1000 |

PWC2A, PWC2B, PWC3A and PWC3B are powder coating components with the compositions as given in Table 2. These were prepared for making comparative powder coating blends PW2 and PW3, wherein no crystalline components were used in the formulations. To prepare PW2, the catalyst precursor component PWC2A and the activator component PWC2B were blended in a ratio of 50/50. To prepare PW3, the catalyst precursor component PWC3A and the activator component PWC3B were blended in a ratio of 52/48.

Comparative powder coating compositions PW1-PW3 were sprayed onto aluminum Q-panels and cured for 30 minutes at 120° C. The dry film thickness, 60° gloss level, calculated Tgₛₜₒᵣₑ and Tg_{flow} are summarized in Table 3.

TABLE 2
Comparative powder coating components
PWC2A, PWC2B, PWC3A and PWC3B.

| Comparative powder coating | | | | |
|---|---|---|---|---|
| components (values in parts by | | | | |
| weight) | PWC2A | PWC2B | PWC3A | PWC3B |
| Malonate donor | 190 | 190 | 205 | 205 |
| Urethane-acrylate acceptor | 113 | 113 | 146 | 146 |
| Catalyst precursor | 87 | | 67 | |
| Retarder | | 10 | | 7 |
| Almatex ™ PD-3402 | | 88 | | |
| TGIC | | | | 14 |
| Titanium dioxide Kronos ® 2160 | 100 | 100 | 100 | 100 |
| Modaflow ® P6000 | 5 | 5 | 5 | 5 |
| Total | 495 | 505 | 523 | 477 |

TABLE 3
Summary of comparative powder coating composition application
results, calculated Tgₛₜₒᵣₑ and Tg_{flow} for PW1-PW2.

| | PW1 | PW2 | PW3 |
|---|---|---|---|
| Film thickness DFT (μm) | 65-80 | 60-70 | 60-70 |
| Gloss at (60°) | 87 | 22 | 28 |
| Tgₛₜₒᵣₑ (° C.) | 52.4 | 51.9 | 51.2 |
| Tg_{flow} (° C.) | 35.8 | 51.9 | 51.2 |
| Tgₛₜₒᵣₑ − Tg_{flow} (° C.) | 16.5 | 0 | 0 |

A powder coating blends PW4 according to the invention was prepared by blending the powder coating precursor component PWC4A, and the powder coating activator components PWC4B in a ratio of 50/50. A crystalline urethane-acrylate CUA-1 acceptor resin was formulated into both PWC4A and PWC4B. The amount of CUA-1 is 18.7 wt %, and this corresponds to a maximum plasticization of 16.5° C. The overall composition of this powder coating blend according to the invention is identical to the comparative powder coating PW1, in view of the relative amount of donor/acceptor ratio, catalyst precursor concentration and activator concentration. The blend according to invention was sprayed onto aluminum Q-panels and was cured for 30 minutes at 120° C. Compared to comparative non-blend powder coating PW1, the coating blend according to invention PW4 achieved much lower gloss level (<20GU) and had a smooth finish.

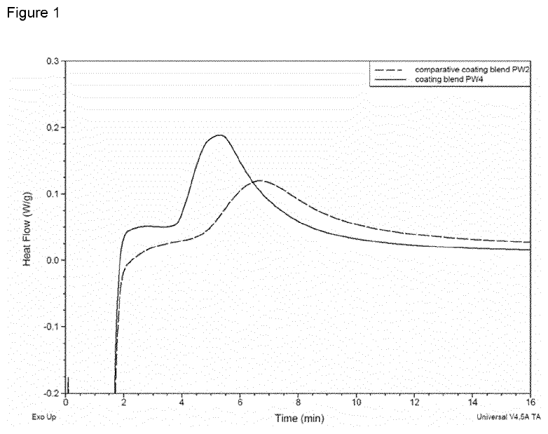

Moreover, coating blend PW4 according to the invention has identical donor/acceptor ratio, catalyst precursor concentration and activator concentration as comparative coating blend PW2, except crystalline urethane-acrylate (CUA-1) has been used in the formulation of PW4. Comparing the gloss level of PW4 and PW2 demonstrates the addition of crystalline component can further reduce the gloss level of blend coating composition, from 22GU to 9GU at 60° angle. FIG. 1 shows the DSC isothermal analysis at 120° C. for both powder coating blends PW4 and PW2. As can be seen from the DSC plots, PW4 has a faster curing speed than PW2, as one set of curing started earlier and the curing exotherm completed faster. It is thought that the crystalline component in PW4 (e.g. CUA-1) has lowered the Tg of the paint (e.g maximum plasticization of 16.5° C.), and consequently reduced the melted viscosity of the powder coating. This facilitates the diffusion of molecules, which might be the reason that the reactivity of the coating blend PW4 is enhanced.

PW5-PW7 are powder coating blends according to the invention. Similarly, they were prepared by blending the powder coating precursor component PWC5A or PWC6A or PWC7A, with the corresponding powder coating activator components PWC4B or PWC5B or PWC6B in a ratio of 50/50. A crystalline urethane-acrylate CUA-1 acceptor resin was formulated into both component A and B. The amount of CUA-1 is 27.4 wt %, 9.6 wt % and 4.8 wt % and corresponds to a maximum plasticization of 23.9° C., 8.6° C. and 3.6° C. for PW5, PW6 and PW7, respectively. The blends PW5-PW7 according to the invention were sprayed onto aluminum Q-panels and were cured for 30 minutes at 120° C. Again, very low gloss level (<20GU) and smooth finishes were achieved for all examples. The composition and application results of PW4-PW7 were summarized in Table 4 and Table 5, respectively.

TABLE 4
Powder coating components PWC4A, PWC4B, PWC5A,
PWC5B, PWC6A, PWC6B, PWC7A and PWC7B.

| Powder coating | | | | | | | | |
|---|---|---|---|---|---|---|---|---|
| components (values in | | | | | | | | |
| parts by weight) | PWC4A | PWC4B | PWC5A | PWC5B | PWC6A | PWC6B | PWC7A | PWC7B |
| Malonate donor | 169 | 169 | 165 | 165 | 173 | 173 | 175 | 175 |
| Crystalline urethane- | 74 | 74 | 108 | 108 | 38 | 38 | 19 | 19 |
| acrylate CUA-1 | | | | | | | | |
| Urethane-acrylate | 60 | 60 | 29 | 29 | 92 | 92 | 108 | 108 |
| acceptor | | | | | | | | |
| Catalyst precursor | 87 | | 87 | | 87 | | 87 | |
| Retarder | | 10 | | 10 | | 10 | | 10 |
| Almatex ™ PD-3402 | | 88 | | 88 | | 88 | | 88 |
| Titanium dioxide | 100 | 100 | 100 | 100 | 100 | 100 | 100 | 100 |
| Kronos ® 2160 | | | | | | | | |
| Modaflow ® P6000 | 5 | 5 | 5 | 5 | 5 | 5 | 5 | 5 |
| Total | 495 | 505 | 495 | 505 | 495 | 505 | 495 | 505 |

TABLE 5
Summary of powder coating blends application results,
calculated Tgₛₜₒᵣₑ and Tg_{flow} for PW4-PW7.

| | PW4 | PW5 | PW6 | PW7 |
|---|---|---|---|---|
| Film thickness DFT (μm) | 70-80 | 60-70 | 55-65 | 70-90 |
| Gloss at (60°) | 9 | 10 | 11 | 13 |
| Tgₛₜₒᵣₑ (° C.) | 52.4 | 53.0 | 51.9 | 51.7 |
| Tg_{flow} (° C.) | 35.8 | 29.1 | 43.2 | 48.1 |
| Tgₛₜₒᵣₑ − Tg_{flow} (° C.) | 16.5 | 23.9 | 8.6 | 3.6 |

PW8 and PW9 are powder coating blends according to the invention, which alternative epoxy compounds have been used as activator. The AMSD-GMA acrylic has lower molecular weight compare to Almatex™ PD-3402. Similarly, they were prepared by blending the powder coating precursor component PWC8A or PWC9A, with the corresponding powder coating activator components PWC8B or PWC9B in a ratio of 47/53 and 52/48, respectively. A crystalline urethane-acrylate CUA-1 acceptor resin was formulated into both component A and B. The amount of CUA-1 is 16.5 wt % and 20.5 wt %, and this corresponds to a maximum plasticization of 14.3° C. and 18.0° C. for PW8 and PW9, respectively. The blends PW8 and PW9 according to the invention were sprayed onto aluminum Q-panels and were cured for 30 minutes at 120° C. Again, very low gloss level (<20GU) and smooth finishes were achieved. Coating blend PW9 according to invention has identical donor/acceptor ratio, catalyst precursor concentration and activator concentration as comparative coating blend PW3, except crystalline urethane-acrylate (CUA-1) has been used in the formulation of PW9. Comparing the gloss level of PW9 and PW3 demonstrates the addition of crystalline component can further reduce the gloss level of blend coating composition, from 28GU to 10GU at 60° angle.

PW10 is a coating blend according to the invention, which an alternative crystalline urethane-acrylate CUA-2 has been used in the formulation. CUA-2 has higher maximum and end DSC melting temperatures than CUA-1. PW10 was prepared by blending powder coating precursor component PWC10A, with the corresponding powder coating activator components PWC10B in a ratio of 49/51. A crystalline urethane-acrylate CUA-2 acceptor resin was formulated into both component A and B. The amount of CUA-2 is 18.8 wt % and this correspond to a maximum plasticization of 13.9° C. . . . The blends PW10 according to the invention was sprayed onto aluminum Q-panels and was cured for 30 minutes at 120° C. Again, very low gloss level (<20GU) and smooth finishes were achieved. The composition and application results of PW8-PW10 were summarized in Table 6 and Table 7, respectively.

TABLE 6
Powder coating components PWC8A, PWC8B,
PWC9A, PWC9B, PWC10A and PWC10B.

| Powder coating components | | | | | | |
|---|---|---|---|---|---|---|
| (values in parts by weight) | PWC8A | PWC8B | PWC9A | PWC9B | PWC10A | PWC10B |
| Malonate donor | 160 | 160 | 199 | 199 | 162 | 162 |
| Crystalline urethane-acrylate | 65 | 65 | 81 | 81 | | |
| CUA-1 | | | | | | |
| Crystalline urethane-acrylate | | | | | 74 | 74 |
| CUA-2 | | | | | | |
| Urethane-acrylate acceptor | 57 | 57 | 70 | 70 | 57 | 57 |
| Catalyst precursor | 87 | | 68 | | 87 | |
| Retarder | | 10 | | 8 | | 38 |
| AMSD-GMA | | 129 | | | | |
| TGIC | | | | 14 | | |
| Almatex ™ PD-3402 | | | | | | 78 |
| Titanium dioxide Kronos ® | 100 | 100 | 100 | 100 | 100 | 100 |
| 2160 | | | | | | |
| Modaflow ® P6000 | 5 | 5 | 5 | 5 | 5 | 5 |
| Total | 474 | 526 | 523 | 477 | 485 | 514 |

TABLE 7
Summary of powder coating blends application results,
calculated Tgₛₜₒᵣₑ and Tg_{flow} for PW8-PW10.

| | PW8 | PW9 | PW10 |
|---|---|---|---|
| Film thickness DFT (μm) | 80-90 | 60-65 | 75-90 |
| Gloss at (60°) | 14 | 10 | 7 |
| Tgₛₜₒᵣₑ (° C.) | 51.1 | 52.3 | 53.1 |
| Tg_{flow} (° C.) | 36.8 | 34.3 | 39.2 |
| Tgₛₜₒᵣₑ − Tg_{flow} (° C.) | 14.3 | 18.0 | 13.9 |

1. A two component powder coating composition AB comprising paint component A and paint component B, wherein the powder coating composition AB comprises
a crosslinkable composition, formed by a crosslinkable donor component (i) and a crosslinkable acceptor component (ii) that are crosslinkable by a Real Michael Addition (RMA) reaction, wherein
the donor component (i) has at least 2 acidic C—H donor groups in activated methylene or methine, and
the acceptor component (ii) has at least 2 activated unsaturated acceptor groups C═C, which react with donor component (i) by Real Michael Addition (RMA) reaction via a catalyst system,
the catalyst system comprising a catalyst precursor (P) and a catalyst activator (C), which are separated so that
paint component A comprises the catalyst precursor (P);
paint component B comprises the catalyst activator (C);
wherein the catalyst precursor (P) is a weak base with a pKa of its protonated form of more than 2 units lower than that of the activated C—H groups in donor component (i); and the catalyst activator (C) can react with (P) at curing temperature Tcur, producing a strong base (CP);
optionally a non-RMA reactive component (iii) different from the donor component (i), the acceptor component (ii), the catalyst precursor (P) and the catalyst activator (C), wherein the coating composition AB comprises a crystalline component CC, that is present in an amount from 1 to 50 wt %, preferably 2 to 40 wt % and more preferably from 4 to 30 wt % in view of the total weight of the catalyst system, the crosslinkable composition and if present the non-RMA reactive component (iii);
whereby at least part of the donor component (i) and/or acceptor component (ii) and/or the non-RMA reactive component (iii) is the crystalline component CC; and
wherein both paint components A and B comprise the donor component (i) and the acceptor component (ii).

2. The two component powder coating composition AB according to claim 1,
characterized by a maximum plasticization effect due to melting of the crystalline component CC, calculated as Tgₛₜₒᵣₑ−Tg_{flow}, of 2 to 50° C., preferably 3 to 40° C., more preferably 4 to 30° C., wherein Tgₛₜₒᵣₑ and Tg_{flow} are calculated as
$$\frac{{\sum }_{i = 1}^{n} {W}_{i}}{{Tg}_{store}} = {\sum }_{i = 1}^{n} \frac{{W}_{i}}{{Tg}_{i}} \qquad \frac{{\sum }_{j = 1}^{n} {W}_{j}}{{Tg}_{flow}} = {\sum }_{j = 1}^{m} \frac{{W}_{j}}{{Tg}_{j}}$$
wherein in the formula
i represents each individual component of the catalyst system, the crosslinkable composition and if present the non-RMA reactive component (iii) not including the crystalline components CC;
j represents each individual component of the catalyst system, the crosslinkable composition and if present the non-RMA reactive component (iii) including the crystalline component CC;
·Tgi and Tgj represent the glass transition temperature Tg, in Kelvin, as the midpoint value determined by Differential Scanning calorimetry (DSC) at a cooling rate of 10° C./min, of the individual components of the catalyst system, the crosslinkable composition and if present the non-RMA reactive component (iii);
wi or wj is the weight fraction w of the individual component in view of the total weight of the catalyst system, the crosslinkable composition and if present the non-RMA reactive component (iii).

3. The two component powder composition AB according to claim 1, wherein the catalyst system further comprises a catalyst retarder material T, which is an acid that has a pKa of more than 2 points lower than that of the activated C—H of the donor component (i), and which upon deprotonation produces a weak base that can react with the catalyst activator C, producing a strong base that can catalyse the RMA reaction between the components (i) and (ii).

4. The two component powder composition AB according to claim 1, in wherein precursor (P) is present in an amount from 20 to 400 meq/g, preferably 30 to 250 meq/g, more preferably 60 to 130 meq/g, in view of total weight of the catalyst system, the crosslinkable composition and if present the non-RMA reactive component (iii).

5. The two component powder composition AB according to claim 1, wherein activator (C) is present in an amount from 60 to 1200 meq/g, preferably 90 to 750, even more preferably 180 to 390 meq/g in view of the total weight of the catalyst system, the crosslinkable composition and if present the non-RMA reactive component (iii).

6. The two component powder composition AB according to claim 1, wherein retarder (T) is present in an amount from 10-800, 15-500, 30-260 meq/g in view of the total weight of the catalyst system, the crosslinkable composition and if present the non-RMA reactive component (iii).

7. The two component powder composition AB according to claim 1, wherein the crystalline component CC has a melting temperature below 140° C. preferably below 120° C., even more preferably below 110° C. or even 100° C.

8. The two component powder composition AB according to claim 1, wherein the crystalline component CC is present in both paint components A and B at an amount whereby the difference of the weight fraction of the crystalline component CC in view of the weight of paint component A and paint component B, is less than 5 wt %.

9. The two component powder composition AB according to claim 1, wherein the crystalline component CC, is a polyurethane compound, preferably a polyurethane made by reacting hexamethylene diisocyanate with a isocyanate reactive group, and preferably has a Mn of more than 500, 750, 1000, and less than 5000, 4000, 3000.

10. The two component powder composition AB according to claim 9, wherein the isocyanate reactive group is a diol preferably selected from the group consisting of diethylene glycol; triethylene glycol; 3-methyl 1,5-pentanediol, 2-methyl 1,3-propane diol; thio diethanol; dithio diethanol; bis(hydroxyethyl)methyl amine; tetraethylene glycol; di(1,3-propanediol); di(1,4-butanediol), preferably diethyleneglycol or 3-methylpentanediol.

11. The two component powder composition AB according to claim 1, wherein both paint components A and B have a Tg higher than 35° C., preferably higher than 40° C. and preferably lower than 60° C., more preferably lower than 55° C., wherein Tg is the midpoint value determined by Differential Scanning calorimetry (DSC) at a heating rate of 10° C./min.

12. The two component powder coating composition AB according to claim 1, wherein the weight ratio of paint components A and B is between 0.1 and 10, preferably 0.2 and 5, more preferably between 0.33 and 3, even more preferable between 0.5 and 2, most preferably between 0.75 and 1.33.

13. The two component powder coating composition AB according to claim 1, wherein at least one of crosslinkable components (i) or (ii) is a polymer, preferably chosen from the group of acrylic, polyester, polyester amide, polyester-urethane polymers, which polymer
has a number average molecular weight Mn, as determined with GPC, of at least 450 g/mole, preferably at least 1000, more preferably at least 1500 and most preferably at least 2000 g/mole;
has a weight average molecular weight Mw, as determined with GPC, of at most 20000 g/mole, preferably at most 15000, more preferably at most 10000 and most preferably at most 7500 g/mole;
preferably has a polydispersity Mw/Mn below 4, more preferably below 3;
has an equivalent weight EQW in C—H or C═C of at least 150, 250, 350, 450 or 550 g/mole and preferably at most 2500, 2000, 1500, 1250 or 1000 g/mole and a number average functionality of reactive groups C—H or C═C between 1-25, more preferably 1.5-15 even more preferably 2-15, most preferably 2.5-10 C—H groups per molecule;
preferably has a melt viscosity at a temperature in the range between 10° and 140° C. less than 60 Pas, more preferably less than 40, 30, 20, 10 or even 5 Pas;
preferably comprises amide, urea or urethane bonds and/or comprises high Tg monomers, preferably cycloaliphatic or aromatic monomers, in particular polyester monomers chosen from the group of 1,4-dimethylol cyclohexane (CHDM), tricyclodecanedimethanol (TCD diol), isosorbide, penta-spiroglycol or hydrogenated bisphenol A and tetramethyl-cyclobutanediol; and/or
has a Tg above 25° C., preferably above 35° C., more preferably above 40, 50 or even 60° C. as the midpoint value determined by DSC at a heating rate of 10° C./min or is a crystalline polymer with a melting temperature between 40° C. and 150, preferably 130° C., preferably at least 50 or even 70° C. and preferably lower than 120° C. (as determined by DSC at a heating rate of 10° C./min).

14. The two component powder coating composition AB according to claim 1, in which the activator (C) is selected from the group of epoxide, carbodiimide, oxetane, vinyl ether, oxazoline or aziridine functional components, preferably an epoxide or carbodiimide, preferably an epoxide from the group of TGIC, GMA acrylics, other glycidyl esters, or phenolic glycidyl ethers.

15. The two component powder coating composition AB according to claim 1, in which the catalyst precursor (P) is a weak base nucleophile anion chosen from the group carboxylate, phosphonate, sulphonate, halogenide or phenolate anions, or a non-ionic nucleophile, preferably a tertiary amine, or phosphine; more preferably a weak base nucleophile anion chosen from the group carboxylate, halogenide or phenolate anions or 1,4-diazabicyclo-[2.2.2]-octane (DABCO) or an N-alkylimidazole, most preferably a carboxylate; whereby in case the retarder (T) is present it is preferably a protonated precursor (P).

16. The two component powder coating composition AB according to claim 1, in which the catalyst precursor (P) is added as a salt comprising a cation that is not acidic, preferably a cation according to formula Y(R′)₄, wherein Y represents N or atom P, and wherein each R′ can be a same or different alkyl, aryl or aralkyl group possibly linked to a polymer or wherein the cation is a protonated very strong basic amine, which very strong basic amine is preferably selected from the group of amidines; preferably 1,8-diazabicyclo(5.4.0) undec-7-ene (DBU), or guanidines; preferably 1,1,3,3-tetramethylguanidine (TMG).

17. The two component powder coating composition AB according to claim 1, which comprises a total amount donor groups C—H and acceptor groups C═C per gram binder solids from 0.05 to 6 meq/gr binder solids and preferably the ratio of acceptor groups C═C to donor groups C—H is more than 0.1 and less than 10.

18. The two component powder coating composition AB according to claim 1, wherein the composition is prepared by
melt-mixing components (i) and/or (ii) of the crosslinkable system with the catalyst precursor (P) and optionally the retarder T to obtain component A extrudate;
melt-mixing components (i) and/or (ii) of the crosslinkable system with the catalyst activator (C) and optionally the retarder T to obtain component B extrudate;
solidifying and granulating the component A extrudate and component B extrudate to obtain paint component A and paint component B;
dry blending the paint component A and paint component B to obtain the two component powder coating composition AB.

19. A method for powder-coating a substrate comprising
a. applying a layer comprising the two component powder coating composition AB according to claim 1, to a substrate surface wherein the substrate preferably is a temperature sensitive substrate, preferably MDF, wood, plastic, composite or temperature sensitive metal substrates like alloys and
b. heating to a curing temperature Tcur between 75 and 150° C.
c. curing at Tcur for a curing time preferably less than 40 minutes.

20. Articles coated with the two component powder coating composition AB according to claim 1, wherein the articles preferably have a temperature sensitive substrate preferably selected from the group of MDF, wood, plastic or metal alloys and wherein the gloss level is less than 20GU at 60° angle.

21. Articles coated with the two component powder coating composition AB according to claim 20, wherein preferably the crosslinking density XLD is at least 0.01, mmol/ml (as determined by DMTA) and is preferably lower than 3.
